(19) United States
(12) Patent Application Publication
(10) Pub. No.: US 2016/0000191 A1
(43) Pub. Date: Jan. 7, 2016

(54) Pull and Release Latch

(71) Applicants: Abbas Haider, Fairfax, VA (US); Robert Imre Davis, Locust Groove, VA (US); Robert Michael Romano, Spring, TX (US); Daniel Isaac Armstrong, Roanoke, VA (US); Daniel Edgar Nelson, Louisville, KY (US)

(72) Inventors: Abbas Haider, Fairfax, VA (US); Robert Imre Davis, Locust Groove, VA (US); Robert Michael Romano, Spring, TX (US); Daniel Isaac Armstrong, Roanoke, VA (US); Daniel Edgar Nelson, Louisville, KY (US)

(21) Appl. No.: 14/324,323

(22) Filed: Jul. 7, 2014

(51) Int. Cl. A44B 11/25; F16B 45/02; F41H 1/02; A44B 11/22

(52) U.S. Cl. CPC A44B 11/2592; A44B 11/22; F16B 45/025; F41H 1/02

(57) ABSTRACT

A pull and release latch including a releasable lock featuring stress preventers and a limit stop. The limit stop prevents the releasable lock from cantilevering too much to the point of breaking or stressing the releasable lock. A unique design allows a male component and a female component to be easily engaged while at the same time the pulling force to release the lock gives the same motion to separate the two components in a direction perpendicular to a cantilever axis.

### TECHNICAL FIELD

This latch pertains to those latches that are quick release by pulling on a string and pulling on one of the two components to separate from one another. The latch is used to detachably connect straps together, in particular, straps used to assemble or disassemble a bulletproof vest from a person's body.

### BACKGROUND OF THE INVENTION

A known latch is shown in FIGS. 6-8. It shows a latch 30 where the direction of removal of one of the components is along a cantilever axis A1 of an engagement lock 31c. This type of latch requires two steps to separate the two components 31, 41 making this type of latch cumbersome. The first step is to pull on a string, not shown, in one direction to disengage the engagement lock 31c. Thereafter, one has to pull the disengaged component 31 in a direction along the cantilever axis A1 thus adding another step and applying separate forces to fully separate the two components 31, 41. The prior art latch also features a limit block 31 a and limit stop 31 b so the disengagement lock 31c is limited in cantilever motion thus preventing breakage. While latches have been known to latch components together and separate by either pulling a string, the invention does not seek to cover this aspect of pulling a lock with a string.

Another well-known latch is that found in backpacks where one has to press tabs to release. The direction of pressing is perpendicular to the cantilever axis and having the separation of the two components of the latch going perpendicular to the cantilever axis.

### SUMMARY OF THE INVENTION

One aspect of the present invention is a quick release latch comprising female and male components that engage with each other. The female and male components integrate notches for attaching removable straps. Another aspect of the present invention allows for a user to separate the components apart by merely pulling a string or cord attached to a cantilever wall of the female component thus disengaging the components by the same force applied to the string to disengage a catch of the cantilever wall. The same force applied to the string translates into the motion of the female component causing separation from the male component.

Another aspect of the present invention is the integration of a stronger limit stop and a guiding feature that allows the male component to be guided into proper engagement in the female component. A further aspect is the inclusion of stress relievers to extend the life of the cantilever wall.

### BRIEF DESCRIPTION OF THE DRAWINGS

FIG. 1 is a perspective view of a pull-and-release latch in accordance with a first variation of the present invention.

FIG. 2 is a top view of the latch shown in FIG. 1.

FIG. 3 is a cross-sectional view of the latch shown in FIG. 2 showing section 3-3.

FIG. 4 is a sectional view of the assembled latch components.

FIG. 5 is a front view in accordance with a second variation of the present invention.

FIG. 6 is a perspective view of a latch showing the prior art.

FIG. 7 is a front view of the prior art latch shown in in FIG. 6.

FIG. 8 is a cross-section view showing section 8-8 in FIG. 7.

### DETAILED DESCRIPTION OF THE DRAWINGS

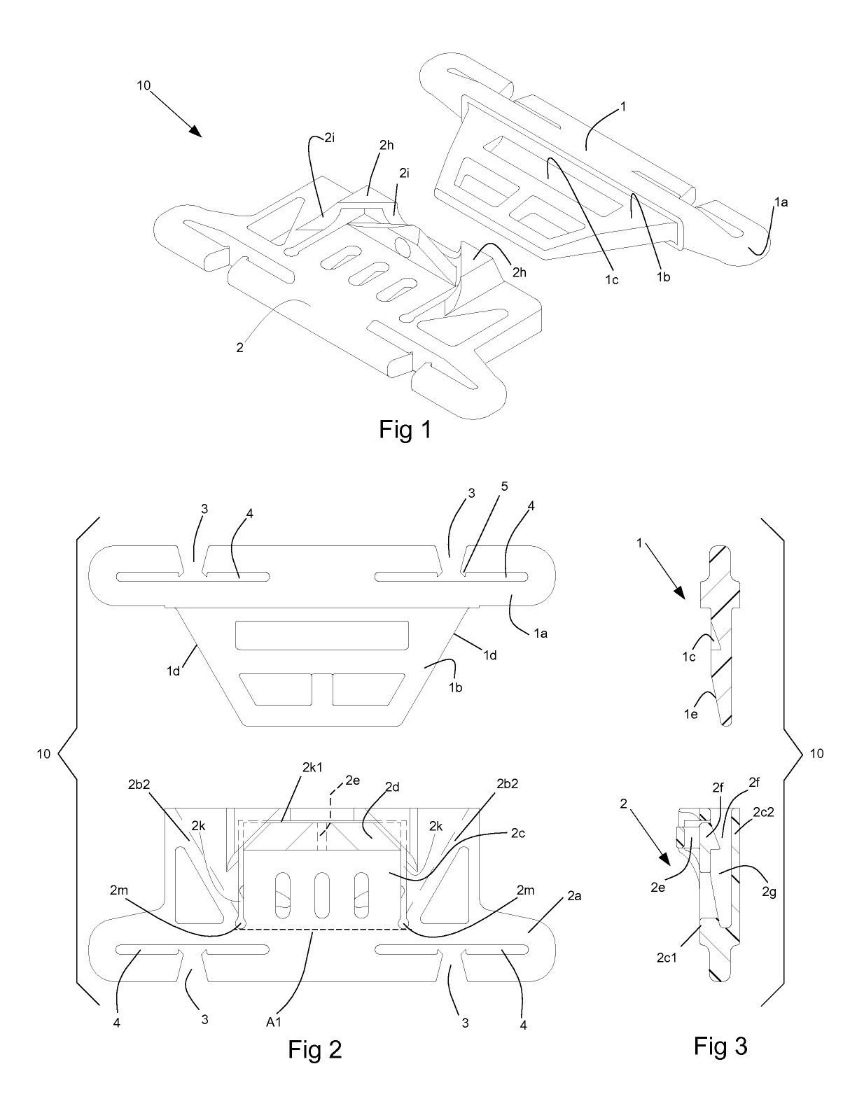

With reference to FIGS. 1 and 2, a quick release latch 10 in accordance with the present invention is shown. The latch 10 comprises a female component 2 and a male component 18. Each of the components 1, 2 carries a pair of hooks 1a, 2a to receive a strap, not shown. The female component 12 has a top wall 2c1, a bottom 2c2, and sidewalls 2b2 together forming a receiving compartment 2b as shown in FIG. 3. The sidewalls 2b2 are tapered to receive a projection 1b of the male component 1. The projection comprising a pair of tapered sidewalls 1d and a leading tapered wall 1e. The top wall 2c1 includes a cantilever wall 2c, which is spaced from a pair of axial slots 2k and a traverse slot 2k1. As shown in FIG. 2, the cantilever wall 2c is fixed at cantilever axis A1 where most stress occurs. To increase the fatigue life of the cantilever wall 2c, each of the axial slots 2k terminates with stress reliever holes 2m. The cantilever wall 2c carries an extension 2d projecting from the cantilever wall 2c where a string, rope, or the like, not shown, can be fitted in through hole 2e so that a user can pull the cantilever wall 2c to disengage the female component 2 from the male component 1.

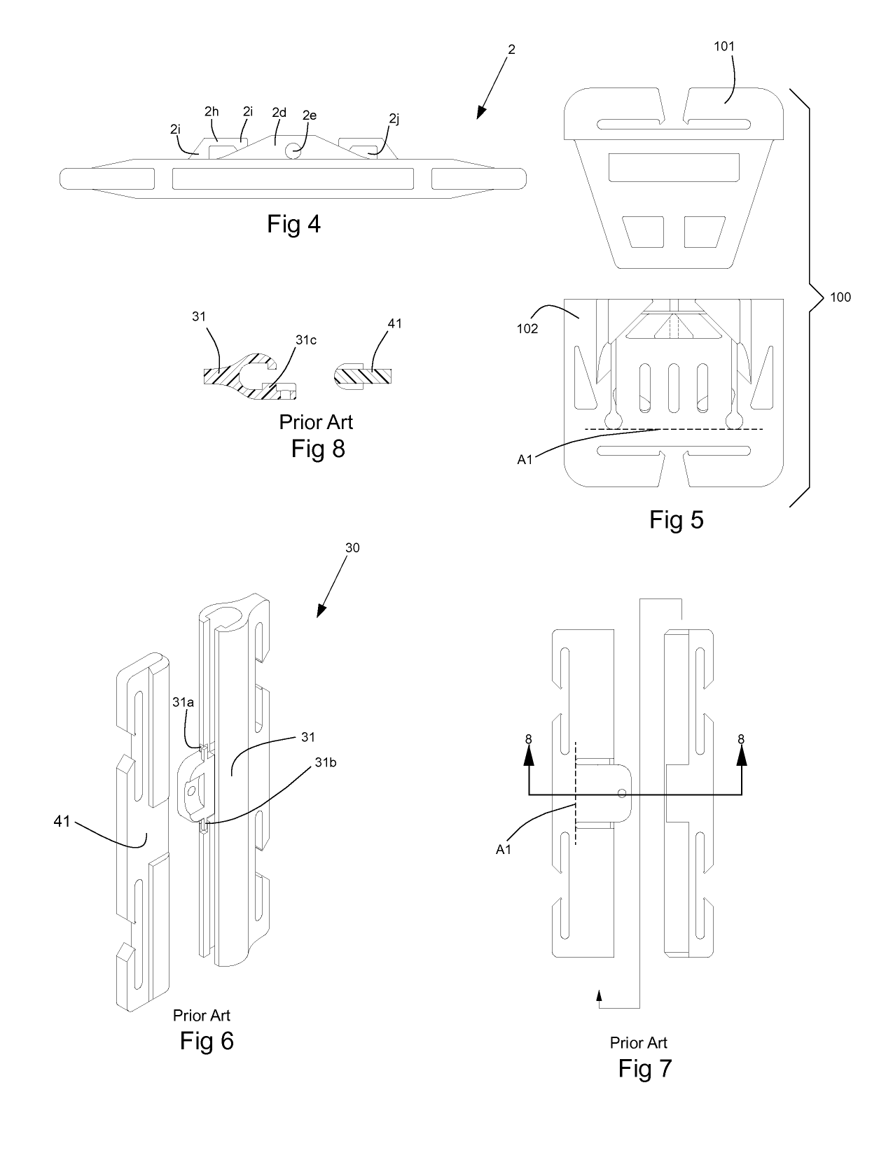

As shown in FIGS. 1 and 3, the cantilever wall 2c carries a releasable lock 2f extending opposite to the extension 2d. The releasable lock 2f serves to catch into a corresponding cavity 1c on the tapered projection 1b of the male component 1. The leading tapered wall 1e of the male component 1 serves to push the lock 2f away thus allowing the lock 2f to easily engage the cavity 1c. To prevent overstressing the cantilever wall 2c, the latch 10 is equipped with a motion stop 2h, which is spaced parallel to the top wall 2c1. A pair of anchors 2i, as shown in FIGS. 1 and 4, bridges the motion stop 2h and covers a corner section of the releasable lock 2f. It should be noted that one of the anchors 2i is parallel to the axial slots 2k and the other anchor 2i is parallel to the traverse slot 2k1. These motions stops 2h prevent anyone pulling on the cantilever wall 2c from pivoting more than cantilever wall 2c would to avoid overstressing and breaking the cantilever wall 2c.

To separate the male and female components 1, 2, one will simply pull on the cantilever wall 2c via a string or rope, not shown. The pulling force on the female component 2 will separate the lock 2f from the cavity 1c thus disengaging the two components while the same pulling force transfers into separating the two components perpendicular to the cantilever axis A1. Of course, it should go without saying that for separation to occur, an anchor force opposite to the pulling force needs to take place for separation to occur. This would happen when the male component is anchored to a fixed point such as a bulletproof vest. When pulling on the female component 2, portions of the vest will become separated.

While the invention is envisioned to be used with belts or straps that fit on the hooks 1a, 2a by fitting the belt or strap through a mouth 3 leading to an opening 4, the hook 1a, 2a can be of any shape and size as long it hold a strap or belt. The mouth 3 includes biting hooks 5 that would bite into the strap or belt to prevent sliding out. The biting hooks 5 project into the opening 4. It is envisioned that one can just put one hook 1a, 2a as shown in the latch 100 shown in FIG. 5. In this second embodiment, the male 101 and female component 102 carry at least one hook similar in shape to that shown in FIGS. 1-4.

Other modification can be envisioned, in particular, one can utilize any know material to make the latch. In particular, a material that is flexible such as plastic, metal, or a combination thereof. The corresponding cavity 1c of the male components can be placed in opposite sides to make the male component 1 reversible. The male and female component can include material reduction through holes to reduce the weight. All edges can either be blended or rounded to increase strength or reduce sharp edges. While the application herein disclosed is to bulletproof vests, the latch can be applied to many applications requiring separation of two components.

1. A latch comprising a male component and a female component;
the female component comprising a top wall, a bottom wall, and sidewalls forming a receiving compartment; and,
the top wall comprising a cantilever wall spaced from a pair of axial slots and a transverse slot.

2. The latch of claim 1, wherein the male component comprises tapered walls to be received on the receiving compartment having a corresponding shape.

3. The latch of claim 1, wherein the female component comprises a releasable lock engageable with a cavity of the male component.

4. The latch of claim 1, wherein the axial slots terminate with stress relieve holes.

5. The latch of claim 3, wherein the cantilever wall further comprises a projection opposite to the releasable lock and wherein the projection further includes a through hole to string a cord or cable.

6. The latch of claim 3, wherein the male component comprises a front tapered wall to flex the releasable lock.

7. The latch of claim 3, wherein the female component includes at least one motion stop to limit the cantilever wall from flexing too much.

8. The latch of claim 7, wherein the motion stop is parallel to the top wall and includes at least one anchor bridging the motion stop from the top wall and covering a section of the cantilever wall.

9. The latch of claim 7, wherein the limit stop is parallel to the top wall and includes two anchors bridging the motion stop from the top wall and covering a section of the cantilever wall; and,
wherein one of the two anchors is parallel to axial slots and the other anchor is parallel to the transverse slot.

10. The latch of claim 9, wherein the male and female components include at least one hook to receive a strap or belt.

11. The latch of claim 10, wherein the hook includes a mouth leading to an opening.

12. The latch of claim 11, wherein the mouth includes biting hooks projecting into the opening of the hooks.

13. The latch of claim 1, wherein the cantilever wall defines a cantilever axis at an anchor point; and,
wherein the male component and female component being separable perpendicular to the cantilever wall.

14. A latch comprising a male component and a female component;
the female component comprising a top wall, a bottom wall, and sidewalls forming a receiving compartment;
the top wall comprising a cantilever wall spaced from a pair of axial slots and a transverse slot;
wherein the male component comprises tapered walls to be received on the receiving compartment having a corresponding shape;
wherein the female component comprises a releasable lock engageable with a cavity of the male component; and,
wherein the female component includes at least one motion stop to limit the cantilever wall from flexing too much.

15. The latch of claim 14, wherein the limit stop is parallel to the top wall and includes two anchors bridging the motion stop from the top wall and covering a section of the cantilever wall; and,
wherein one of the two anchors is parallel to axial slots and the other anchor is parallel to the transverse slot.

16. The latch of claim 14, wherein the cantilever wall defines a cantilever axis at an anchor point; and,
wherein the male component and female component being separable perpendicular to the cantilever wall.
